(19) United States
(12) Patent Application Publication
(10) Pub. No.: US 2025/0185826 A1
(43) Pub. Date: Jun. 12, 2025

(54) Weighted Pillows

(71) Applicant: Whitney Atkinson, Robstown, TX (US)

(72) Inventor: Whitney Atkinson, Robstown, TX (US)

(21) Appl. No.: 18/978,212

(22) Filed: Dec. 12, 2024

Related U.S. Application Data
(60) Provisional application No. 63/609,195, filed on Dec. 12, 2023.

(51) Int. Cl. A47G 9/10; A47G 9/02

(52) U.S. Cl. CPC A47G 9/10; A47G 9/0253

(57) ABSTRACT

A weighted system for a pillow that comprises an insert comprising fillers and at least one flattened weighted pouch that is attached to the bottom portion of the insert with industrial strength fasteners. The weighted pouch comprises weighted extra heavy poly pellets encased in a poly tubing, which is further encased in a pouch made of water proof or water resistive material. The insert comprising fillers and weighted pouch is enclosed in spun bonded outdoor fabric. Such insert is then placed in a case or cover which can be removed from the insert to replace or wash the case or cover.

### FIELD OF THE INVENTION

The present invention, in general, relates to a weighted pillow or “WILLOWS”. Specifically, the present invention discloses a weighted pillow system comprising an insert that has fillers and at least one flattened weighted pouch that is attached to the internal bottom portion of the insert by industrial strength fasteners. The weighted pouch grounds (i.e., weights down) a pillow so that it is not blown away. The insert is preferably encased in spun, bonded outdoor fabric. The weighted pillow or WILLOWS comprises a case or cover comprising such encased insert.

### BACKGROUND

Pillows are of different types and differ in the manner of construction based on purpose of the pillow. For instance, pillows may be used for aesthetics, comfort, or a combination thereof. They can be used indoors or outdoors. Regardless of the purpose, it is important that the pillow is durable, functional, and has aesthetic appeal.

Outdoor pillows must be designed to withstand exposure to environmental elements including but not limited to exposure to sun, rain, and wind. Currently, emphasis is placed on the pillow material to be stain resistant, fade resistant, water resistant, and mildew resistant. This does not solve the problem of pillows being light and easily blown away by the wind. Moreover, esthetically, weighted pillows may be more easily positionable and arrangeable where additional weight allows a consumer the ability to confidently place a pillow, or configure a set of pillows, with the confidence that the pillow(s) remain in a static or semi-static placement.

Hence, there is a need for a pillow that is not only durable and has aesthetic appeal but is has sufficient weight to not be blown away by wind gusts. The present invention satisfies this need in the art.

While the inventor has set forth the best mode or modes contemplated in carrying out the present invention known to the inventor, such as to enable a person skilled in the art to make and practice the present invention, the preferred embodiments are, however, not intended to be limiting, but are, on the contrary, included in a non-limiting sense apt to amendments, alterations, alternatives and modifications, based primarily on the pillow size and added weight, in light of specification and appended claims forming the current disclosure.

### BRIEF SUMMARY OF THE INVENTION

A weighted system for pillow (outdoor or indoor) comprising an insert that has weighted fillers and at least one flattened weighted pouch. This weighted pouch comprises preferably extra heavy polypropylene (poly) pellets which are encased in a poly tubing. The weighted pouch is further encased in a pouch made of waterproof or water resistive material. This weighted pouch is attached to entire, half, a third, center, or edges of bottom portion of the insert or a combination thereof, such that the weight distribution is concentrated on the bottom of the insert. The weighted pouch is attached to the insert by industry strength fastener, such as hook-and-loop fastener, hook-and-pile fastener, touch fastener, or similar such fasteners. In addition to the weighted pouch, the insert also comprises synthetic down filled feather and a synthetic poly fill to give the pillow a designer “chop” appearance. The insert is made of fabric such as spun bonded outdoor fabric. The insert is further encased in a case or cover that has interlocking mechanism, a flap, hook-and-loop fasteners, hook-and-pile fasteners, or touch fasteners, zipper, or similar such mechanisms. This allows the case to be placed, replaced, removed and/or changed or washed.

In a preferred embodiment of the present invention is a weighting system for a pillow, comprising an insert, where the insert comprises filler and at least one flattened weighted pouch. In one embodiment of the preferred weighting system, the weighted pouch comprises weighted extra heavy poly pellets encased in a poly tubing. In another embodiment of the preferred weighting system, the encased weighted pouch is further encased in a pouch made of waterproof or water resistive material. In yet another embodiment of the preferred weighting system, the waterproof or water resistive material is synthetic, natural or a combination thereof. In yet another embodiment of the preferred weighting system, the synthetic material is plastic, a natural material that is rubber or a combination of synthetic and natural materials.

In another embodiment of the preferred weighting system, the weighted pellets are coated, non-coated, enveloped, or a combination thereof. In yet another embodiment of the preferred weighting system, the weighted pellets are uniformly sized or non-uniformly sized or a combination thereof.

In another embodiment of the preferred weighting system, the weighted pouch is attached to the entire insert, half, a third, center, or edges of bottom portion of the insert or a combination thereof, such that the weight distribution is concentrated on the bottom of the insert and thus the pillow. In yet another embodiment of the preferred weighting system, the weighted pouch is attached to the insert by industry strength fastener that includes but is not limited to hook-and-loop fastener, hook-and-pile fastener, touch fastener, or a combination thereof.

In still yet another embodiment of the preferred weighting system, the fillers in the insert include but are not limited to synthetic down filled feather and a synthetic poly fill. The fillers and the weighted pouch are enclosed in spun bonded outdoor fabric. In yet another embodiment of the preferred weighting system, the insert with the fillers and the weighted pouch is encased in a case or cover or sleeve that has an interlocking mechanism, a flap, hook-and-loop fasteners, hook-and-pile fasteners, or touch fasteners, a zipper or a combination thereof. In still yet another embodiment of the preferred weighting system, the case or cover or sleeve is made of materials comprising synthetic, natural or a combination thereof.

In another preferred embodiment of the present invention is a method of using a weighting system for a pillow that comprises placing an insert in a case, said insert comprising fillers and at least one flattened weighted pouch comprising weighted extra heavy poly pellets encased in a poly tubing. In one embodiment of the preferred method, the encased weighted pouch is further encased in a pouch made of waterproof or water resistive material, said material is synthetic, natural or a combination thereof. In another embodiment of the preferred method, the synthetic material is plastic, said natural material is rubber or a combination of synthetic and natural materials. In yet another embodiment of the preferred method, the weighted pellets are uniformly sized, non-uniformly sized, coated, non-coated, enveloped or a combination thereof.

In another embodiment of the preferred method, the weighted pouch is attached to the entire insert, half, a third, center or edges of bottom portion of the insert or a combination thereof such that the weight distribution is all on the bottom of the insert and thus the pillow. In yet another embodiment of the preferred method, the weighted pouch is attached to the insert by industry strength fastener. Example of the fastener includes but is not limited to hook-and-loop fastener, hook-and-pile fastener, touch fastener, or a combination thereof.

In still yet another embodiment of the preferred method, the fillers in the insert include but are not limited to synthetic down filled feather and a synthetic poly fill. The fillers and the weighted pouch are enclosed in spun bonded outdoor fabric. In yet another embodiment of the preferred method, the case or cover has an interlocking mechanism, a flap, hook-and-loop fasteners, hook-and-pile fasteners, or touch fasteners, a zipper or a combination thereof for placement, removal, repair, replacement or washing of the insert. In still yet another embodiment of the preferred method, the case or cover or sleeve is made of materials comprising synthetic, natural or a combination thereof. Additionally, the pillow itself may be sealed on all sides or may have one to a plurality of access points for the addition and placement of a weighted pouch and/or various fillers which may consist of a zipper, or zippers, buttons, hooks, latches, hook and loops, a combination thereof, or any other mechanism for opening and closure.

### BRIEF DESCRIPTION OF THE DRAWINGS

So that the manner in which the present invention can be better understood, certain illustrations, charts and/or flow charts are appended hereto. It is to be noted, however, that the drawings illustrate only selected embodiments of the inventions and are therefore not to be considered limiting of scope, for the inventions can admit to other equally effective embodiments and applications.

Moreover, advantages and other aspects of the invention will be readily appreciated by those persons having skill in the art and may be better understood with further reference to the accompanying drawings in which like reference characters designate like or similar elements throughout the several figures of the drawings and wherein:

FIGS. 1A and 1B illustrate views of weighted pouch flattened to the bottom of insert inside pillow and fastened to the bottom portion of the pillow.

FIG. 2 illustrates top view of open insert looking down to weighted pouch.

FIGS. 3A-3F illustrate the contents inside the weighted pillows or “WILLOWS”.

FIG. 4 illustrates the outer cover or case of the weighted pillows or WILLOWS.

FIGS. 5A-5C illustrate weighted pillows or WILLOWS of different weights and sizes.

However, it should be understood that the above-described figures are not intended to be limited to only the invention illustrated and to the particular embodiments disclosed, but on the contrary, the intention is intended to disclose all modifications, alternatives and equivalents falling within the spirit and scope of the invention as defined within the claim's broadest reasonable interpretation consistent with the specification. To wit, variations in height, length, width made be accomplished as to accommodate variances in sizes of pillows as may be necessary or required.

### DETAILED DESCRIPTION OF THE PREFERRED EMBODIMENTS

A detailed description of the preferred embodiments of the invention is disclosed and described below. Yet, each and every possible feature, within the limits of the specification, are not disclosed as various iterations are postulated to be in the purview and contemplation of those having skill in the art. It is therefore possible for those that have requisite skill in the art to make and practice the disclosed invention while observing that certain features and spatial arrangements are relative and capable of being scaled, adapted, arranged at various points about the present invention (by inventor, manufacturer or both) that nonetheless accomplishes the remediation of one or more of the infirmities as outlined and discussed above in the field of pillow design and use. As well, individual components of the present invention may be sized (i.e. enlarged or shrunken), and or given increased or decreased weight, so long as the proportions are maintained that allow for maintaining of esthetic appearance and/or proper functioning of the present invention that may be sized and shaped according to the size of the pillow.

Equally, it should be observed that the present invention can be understood, in terms of structure, function, or both, from the present disclosure as well as those appended claims taken in context with the associated drawings. And whereas the present invention and method of use are capable of several different embodiments and permutations, which can be modified into several different configurations, each exhibiting accompanying interchangeable functionalities, without departing from the scope and spirit of the present application as shown and described.

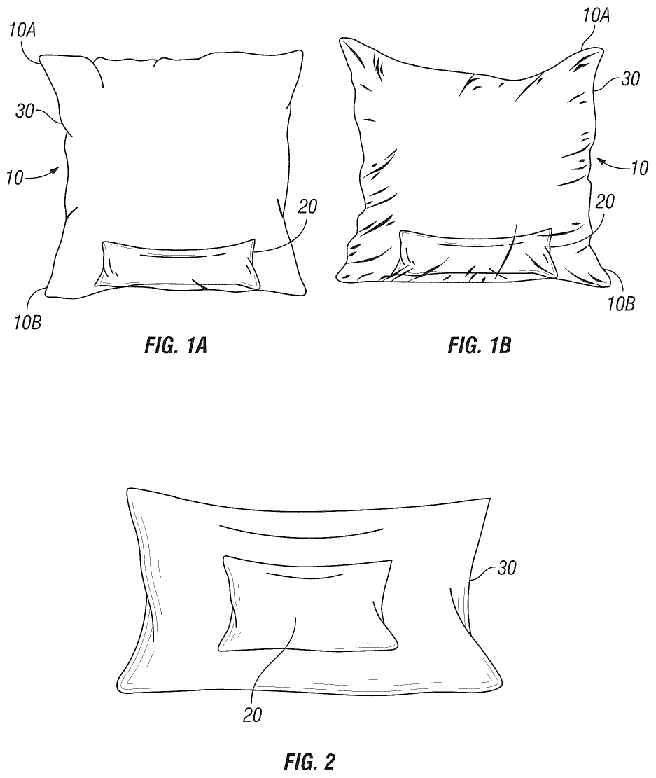

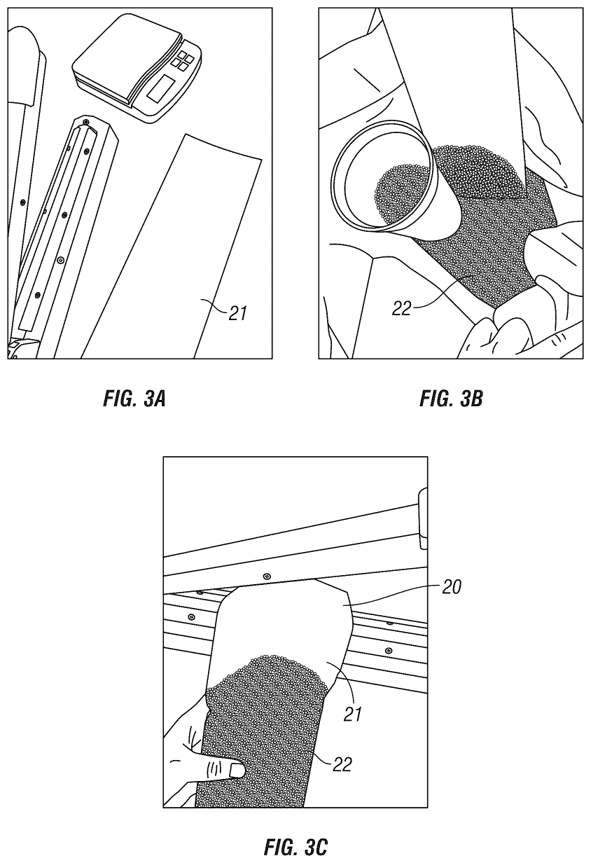

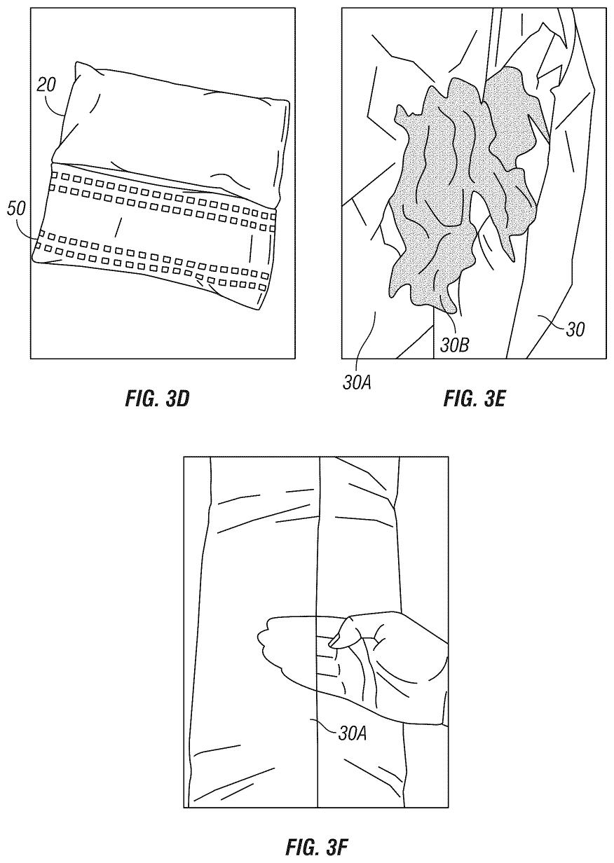

As detailed in FIGS. 1A and 1B, weighted pillow or “WILLOWS” 10 has a top portion 10A and bottom portion 10B. Inside weighted pillow or “WILLOWS” 10 is an insert 30 that is made of spun, bonded outdoor material 30A shown in FIG. 3F. Insert 30 comprises a flattened weighted pouch 20 that is detachably attached to entire bottom, half, a third, center, edges or a combination thereof of bottom portion of insert 30. Insert 30 is also filled with a mixture of synthetic down filled feather and a synthetic poly fill (together known as “fillers 30B”) as shown in FIG. 3E to add designer chop to the weighted pillow or “WILLOWS” 10. Insert 30 may then introduced into an outer covering that is a pillow slip or sleeve that may be made of various materials, designs, patterns, colors and/or appearances. Too, insert 30 itself may alternatively constitute the entire pillow or “WILLOW” 10 with the aforementioned defining esthetic and/or functional features.

As shown in FIG. 1B, the weight distribution is in the bottom portion of insert 30, and it acts like a platform for weighted pillow or “WILLOWS” 10 to rest on so that the weighted pillow or WILLOWS 10 is not blown away by wind gusts up to 70 mph. The fasteners used to attach pouch 20 to bottom portion of insert 30 are of industrial strength including but not limited to hooks, latches, buttons, hook-and-loop fasteners, hook-and-pile fasteners, or touch fasteners (also known as Velcro).

The dimensions of pouch 20 will differ based on the size of insert 30. In other words, pouch 20 may be small or large in size and may be of different geometric shapes. Pouch 20 may be filled with different amounts of weighted pellets 22 shown in FIGS. 3A-3C. Generally, pouch 20 comprises around 3-4 pounds (depending on the size of the insert 30) of extra heavy poly pellets 22 which are encased in a 6 inches poly tubing 21 which may be 12-14 inches long as shown in FIGS. 3A-3C, which is further encased in a pouch made of waterproof or water resistive material 50. However, the dimensions of poly tubing are merely exemplary and may easily be converted to less than 6 inches or more than 6 inches, and less than 12-14 inches long or more than 12-14 inches long, as necessity, function and/or preference or proclivity of the invention operator dictates without departing from the scope and spirit of the invention embodiments described herein. The waterproof or water resistive material 50 is synthetic, natural or a combination thereof. The synthetic materials are plastic, natural materials are rubber or a combination thereof. The final weighted pouch 20 is shown in FIG. 3D.

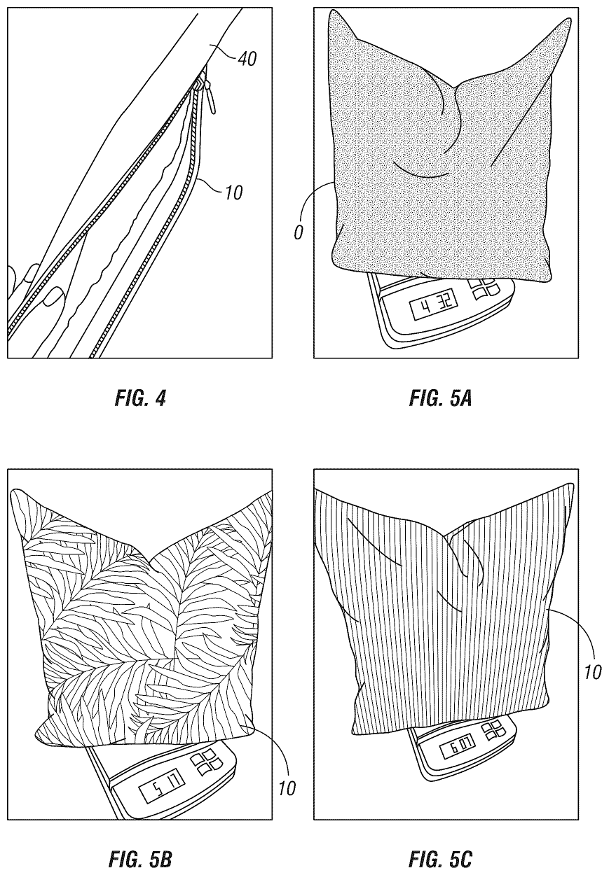

As shown in FIG. 4, insert 30 comprising weighted pouch 20 and fillers 30B weighted and enclosed in a case, cover or sleeve 40, which may have an interlocking mechanism, a flap, hook-and-loop fasteners, hook-and-pile fasteners, or touch fasteners, a zipper, or a combination thereof. This enables the user to remove case 40 from over and around insert 30 and change out or clean and put back on case 40. An example of an opening (e.g., a zipper) for access to the insert 30 includes, for example, an 18 inches zipper. Weighted pillow or “WILLOWS” 10 can be of different weights and dimensions as shown in FIGS. 5A-5C. These sizes include but are not limited to weighted pillow or WILLOWS 10 that are 16 inches and weigh 4 pounds, 18 inches and weigh 5 pounds, or 20 inches and weigh 6 pounds. However, these are merely exemplary and may easily be converted to less than 16 inches or more than 20 inches, and less than 4 pounds or more than 6 pounds, as necessity, function and/or preference or proclivity of the invention operator dictates without departing from the scope and spirit of the invention embodiments described herein.

Although only a select few example embodiments have been described in detail above, those skilled in the art will readily appreciate that many modifications are possible in the example embodiments without materially departing from this disclosure of the invention. Accordingly, all such modifications are intended to be included within the scope of this disclosure as defined in the appended claims.

What is claimed is:

1. A weighting system for a pillow, comprising:
an insert, said insert comprising fillers and at least one flattened weighted pouch.

2. The weighting system of claim 1, wherein the weighted pouch comprises weighted extra heavy poly pellets encased in a poly tubing.

3. The weighting system of claim 2, wherein said encased weighted pouch is further encased in a pouch made of waterproof or water resistive material.

4. The weighting system of claim 3, wherein said waterproof or water resistive material is synthetic, natural or a combination thereof.

5. The weighting system of claim 4, wherein said synthetic material is plastic, said natural material is rubber or a combination of synthetic and natural materials.

6. The weighting system of claim 2, wherein said weighted pellets are coated, non-coated, enveloped, or a combination thereof.

7. The weighting system of claim 1, wherein said pellets are uniformly sized or non-uniformly sized or a combination thereof.

8. The weighting system of claim 1, wherein said weighted pouch is attached to the entire insert, half, a third, center, or edges of bottom portion of the insert or a combination thereof such that the weight distribution is concentrated on the bottom of the insert and thus the pillow.

9. The weighting system of claim 8, wherein said weighted pouch is attached to the insert by industry strength fastener, said fastener comprising hook-and-loop fastener, hook-and-pile fastener, touch fastener, or a combination thereof.

10. The weighting system of claim 1, wherein the fillers in the insert comprise synthetic down filled feather and a synthetic poly fill, wherein said fillers and the weighted pouch are enclosed in spun bonded outdoor fabric.

11. The weighting system of claim 1, wherein the insert with the fillers and the weighted pouch is encased in a case or cover or sleeve that has an interlocking mechanism, a flap, hook-and-loop fasteners, hook-and-pile fasteners, or touch fasteners, a zipper, or a combination thereof for placement, removal, repair, replacement or washing of the insert.

12. The weighting system of claim 11, wherein the case or cover is made of materials comprising synthetic, natural or a combination thereof.

13. A method of using a weighting system for a pillow, comprising:
placing an insert in a case, said insert comprising fillers and at least one flattened weighted pouch comprising weighted extra heavy poly pellets encased in a poly tubing.

14. The method of claim 13, wherein said encased weighted pouch is further encased in a pouch made of waterproof or water resistive material, said material is synthetic, natural or a combination thereof.

15. The method of claim 14, wherein said synthetic material is plastic, said natural material is rubber or a combination of synthetic and natural materials.

16. The method of claim 13, wherein said weighted pellets are uniformly sized, non-uniformly sized, coated, non-coated, enveloped, or a combination thereof.

17. The method of claim 13, wherein said weighted pouch is attached to the entire insert, half, a third, center, or edges of bottom portion of the insert or a combination thereof such that the weight distribution is concentrated on the bottom of the insert and thus the pillow.

18. The method of claim 17, wherein said weighted pouch is attached to the insert by industry strength fastener, said fastener comprising hook-and-loop fastener, hook-and-pile fastener, touch fastener, or a combination thereof.

19. The method of claim 13, wherein the fillers in the insert comprise synthetic down filled feather and a synthetic poly fill, wherein said fillers are enclosed in spun bonded outdoor fabric.

20. The method of claim 13, wherein the case or cover or sleeve has an interlocking mechanism, a flap, hook-and-loop fasteners, hook-and-pile fasteners, or touch fasteners, a zipper, or a combination thereof for placement, removal, repair, replacement or washing of the insert.

21. The method of claim 13, wherein the case or cover is made of materials comprising synthetic, natural or a combination thereof.
